(19) United States
(12) Patent Application Publication
(10) Pub. No.: US 2023/0398648 A1
(43) Pub. Date: Dec. 14, 2023

(54) MACHINE TOOL FOR THE SHAPING PRODUCTION OF AN ARTICLE AND METHOD FOR PRODUCING AN ARTICLE

(71) Applicant: Carl Freudenberg KG, Weinheim (DE)

(72) Inventors: Joerg AVEMANN, Heppenheim (DE); Steven DEPPER, Ludwigshafen (DE); Dominik KRAUS, Moerlenbach (DE); Robert WAGNER, Heppenheim (DE); Bernd WOLF, Kleiningersheim (DE)

(21) Appl. No.: 18/250,363

(22) PCT Filed: Sep. 15, 2021
(86) PCT No.: PCT/EP2021/075308

§ 371 Date: Apr. 25, 2023

(30) Foreign Application Priority Data
Oct. 26, 2020 (DE) 10 2020 128 061.0

(51) Int. Cl. B23Q 3/155

(52) U.S. Cl. CPC B23Q 3/15503

(57) ABSTRACT

A machine tool for the shaping production of an article, including a tool receptacle, a tool feed, a stock of tools, and a controller, wherein the machine tool is configured to select one of the tools from the stock in dependence on the article to be produced and to fasten the article to the tool receptacle.

### CROSS REFERENCE TO RELATED APPLICATIONS

This application is a U.S. National Phase application under 35 U.S.C. § 371 of International Application No. PCT/EP2021/075308, filed on Sep. 15, 2021, and claims benefit to German Patent Application No. DE 10 2020 128 061.0, filed on Oct. 26, 2020. The International Application was published in German on May 5, 2022 as WO 2022/089828 A1 under PCT Article 21(2).

### FIELD

The invention relates to a shaping machine tool for producing an article. The invention further relates to a method for producing an article.

### BACKGROUND

Machine tools are used in a variety of ways in manufacturing technology. Machine tools are used to produce semi-finished products, articles or ready-for-trade items by machining. Machine tools for metalworking can be equipped here with different tools, which are adapted to the processing of different materials or the production of a specific article. Known machine tools are, for example, cutting machine tools, such as lathes and milling machines, and shaping machine tools, such as presses and stamping machines. The stamping process is non-cutting and is usually performed on shaping machine tools. Presses and stamping machines are designed comparably, wherein stamping machines, in particular automatic stamping machines, are additionally equipped with a feed apparatus in comparison to a press.

In general, depending on the article to be produced, it is known to perform a tool change manually, which is relatively time-consuming. Furthermore, it is known to equip machine tools with a tool receptacle which is provided with a stock of tools which can be moved into a working position by the tool receptacle. With these machine tools, the selection of available tools is limited. Furthermore, this type of tool stocking system is not suitable for every type of machine tool. Such tool stocking systems are known for cutting machine tools.

Particularly in the production of small series of articles to be shaped, the problem arises that either a small series is produced, which is associated with frequent tool changes, or a large series of an article is produced, which in turn is associated with extensive warehousing of the articles produced. Both are associated with higher costs.

### SUMMARY

In an embodiment, the present disclosure provides a machine tool for the shaping production of an article, comprising a tool receptacle, a tool feed, a stock of tools, and a controller, wherein the machine tool is configured to select one of the tools from the stock in dependence on the article to be produced and to fasten the article to the tool receptacle.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an automatic stamping machine.

### DETAILED DESCRIPTION

In an embodiment, the present invention provides a shaping machine tool that allows a fast tool change.

In an embodiment, a machine tool for the shaping production of an article comprises a tool receptacle, a tool feed, a stock of tools and a control device, wherein the machine tool is set up to select a tool from the stock in dependence on the article to be produced and to fasten it to the tool receptacle.

According to an embodiment of the invention, the tool suitable for producing the article is selected in an automated fashion and fastened, likewise in an automated manner, to the tool receptacle. The tool can be fastened using mechanical or hydraulic fastening means, wherein the fastening means are preferably designed as clamping means which effect a frictionally engaged fastening of the tool to the tool receptacle. The position of the clamping means can be monitorable here by the control device. The clamping means can be equipped with sensors for this purpose.

A method according to an embodiment of the invention is designed for shaping machine tools, which in the sense of embodiments of the present invention also include stamping machines or automatic stamping machines. In the case of cutting machine tools, cost-effective possibilities for changing tools are already known and can be easily implemented. In the case of cutting tools, the tools and in particular their interface to the tool receptacle are often standardized and the processing parameters can be easily regulated, for example by changing the feed rate and speed of the tool. This makes automated tool changing particularly easy to implement on cutting machine tools.

In the case of shaping machine tools, which also include stamping machines and automatic stamping machines, on the other hand, tool changing is much more difficult. The tools are usually very heavy and the tool receptacle can sometimes only be reached with great difficulty; overhead mounting may be required, for example. Furthermore, a large number of process parameters are adjustable, for example the feed rate, a force that acts on the semi-finished product from the tool and changes depending on the article, and the shaping speed. Another problem is that, especially in automatic stamping machines, the stamping tools and their interface to the tool receptacle are often not standardized. As a result, a manual fitting process is usually required, and automated changeovers, as have long been known for cutting machine tools, for example in the form of tool turrets, are out of the question for shaping machine tools.

The tools can be equipped with a machine-readable code. Preferably, the code can be read remotely. A machine-readable code can be read automatically by a reading device, wherein the tool type is stored for the code in the control device. This makes it possible for the machine tool to have a stock with a plurality of tools, wherein the tools can be transported and read by a suitable transport device. In this case, the code can be read optically or electromagnetically. In the case of optical readability, the tools are provided with an optically readable code, for example a bar code or a DM code (data matrix code). In the case of electromagnetic readability, the readout is performed on active or passive transmitters attached to the tool. RFID tags can be attached to the tools for this purpose, for example.

The control device can comprise an input device for selecting the article. The input device can be implemented here by an interface via which electronic article information can be transferred to the machine tool. In this context, it is also conceivable that a work order in the form of a list of different articles to be produced is transferred via the input device. In this case, the list contains information on the tool required for the production of an article. If an article from the list is to be manufactured, the machine tool can use the list and the tool specified therein to select a tool from the stock of tools and attach it in an automated fashion to the tool receptacle.

The control device can comprise a memory, wherein a list of articles to be produced is stored in the memory, wherein a tool and a machine-readable code belonging to the tool are assigned to the articles to be produced. The list can be entered here into the control device by means of the input device. The list is used to assign tools to the articles to be produced. It is conceivable here to generate the list by means of the input device or to transfer it to the control device via the input device.

A reading device for reading the code can be assigned to the tool feed. The tool feed also preferably comprises a transport device for transporting the tools. The transport device can simultaneously serve to transport the tools and display the stock of tools. For example, the transport device can be designed as a conveyor belt on which the tools are arranged. The tools can be transported here in a circulating manner. The tools pass the reading device and the machine tool selects, in automated fashion, the tool that is assigned to the article to be produced. Alternatively, the transport device can be assigned a separate tool stock, into which the tools can be automatically stored and from which the tools can be automatically removed. It is also conceivable to manage the tool transport between the tool stock and the tool feed with the aid of an automated, driverless transport system.

Subsequently, the tool is fastened in automated fashion to the tool receptacle. Accordingly, the tools can pass the reading device during transport by means of the transport device, wherein the reading device detects the code.

The control device can have an input device for selecting the article to be produced, wherein the control device uses the list to determine the tool required for producing the article. This is automated, so that the entire tool change and fitting process is possible without manual intervention.

The machine tool can be an automatic stamping machine. In the case of automatic stamping machines, changing a tool used to be particularly complex, so that only a few tool changes were possible per work shift. As a result, it has not been possible before now to produce small batches of articles at a reasonable economic cost without warehousing. With the machine tool according to an embodiment of the invention in the form of an automatic stamping machine, the stamping tool can be changed quickly and in automated fashion. This makes it possible to carry out a significantly higher number of tool changes per shift, so that it is also possible to produce small series economically without the need for significant warehousing of produced articles.

In a method according to an embodiment of the invention for producing an article by means of a machine tool, in a first step an article to be produced and the tool required for production are determined, in a second step a tool is selected from the stock of tools, and in a third step the tool is fastened to the tool receptacle, and in a fourth step article-specific production parameters are provided by the control device. After the article has been manufactured in the predetermined quantity, the tool can be removed from the tool receptacle in a fifth step and returned to the stock of tools in a sixth step.

Here, the machine tool is preferably a stamping machine. The stock of tools comprises a transport device for transporting the tools and a reading device for reading the codes which are attached to the stamping tools.

For the production of an article, a list of articles to be produced is stored in the memory of the control unit. A tool and a machine-readable code belonging to the tool are assigned here to each of the articles to be produced. The tools are transported via the transport device and read during transport by means of the reading device. If the reading device detects a tool belonging to the article to be manufactured, it is removed from the stock and attached to the tool feeder. The articles can then be produced.

Once the predetermined quantity of articles to be produced has been generated, the next article and the associated tool are selected from the list. First, the previous tool is removed, as described above, and then the next tool is taken from the stock of tools and attached to the tool receptacle.

An embodiment of the machine tool according to an embodiment of the invention is explained in greater detail below with reference to the figure.

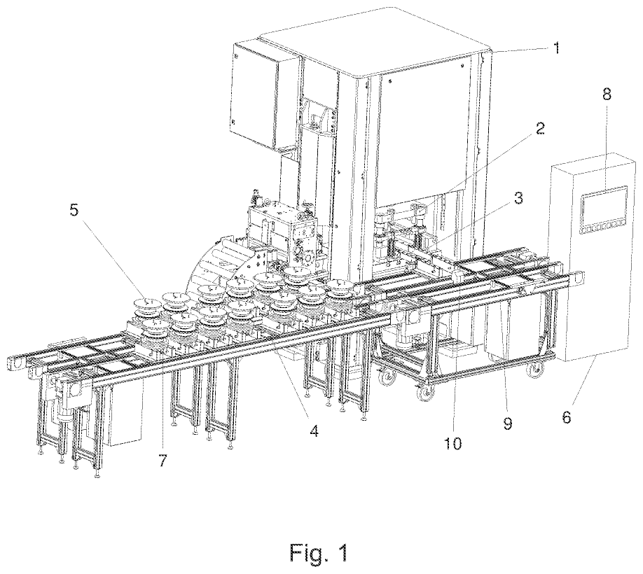

FIG. 1 shows a machine tool 1, which is designed as an automatic stamping machine in the present case. In the machine tool 1, semi-finished products in the form of sheet metal strips are shaped into articles by means of the automatic stamping machine. The machine tool 1 can be designed here, for example, to produce metal support rings for seals from the sheet metal strips.

The machine tool 1 comprises a tool receptacle 2, a tool feed 3, a stock 4 of tools 5, and a control device 6.

The tools 5 are equipped with a machine-readable code 7, wherein the code 7 is preferably in the form of a bar code or DM code and is thus optically readable.

The control device 6 comprises a memory in which a list of articles to be produced can be stored. The list can store the type of articles to be produced, the number of articles to be produced, the tool 5 belonging to the articles to be produced, and a machine-readable code 7 belonging to the tool 5.

The control device 6 is connected to an input device 8. The input device 8 has a control panel for selecting articles stored in the memory 1. Furthermore, the input device 8 is provided with an interface via which lists of articles to be produced can be transferred to the memory.

The control unit 6 monitors the manufacturing process and records when a production order has been completed. As soon as a production order is finished, the control unit 6 initiates the exchange of the tool 5. For the exchange of the tool 5, process steps and process parameters for the exchange process are stored in the control unit 6. The control unit 6 gives corresponding signals to the tool receptacle 2, the transport device 9 and the machine tool 1 in order to carry out the necessary movements for the tool exchange. The tool exchange process includes parameters for both tool removal and tool installation. The control unit 6 also specifies parameters for the cutting device which cuts the strip-shaped semi-finished product to length.

The control unit 6 also causes the correct positioning of the tool 5 and of the press ram. Furthermore, the control unit 6 specifies production parameters for the production of the new article, for example the feed rate and the shaping speed. Accordingly, the control unit 6 contains parameters for both the tool change and the production process. In this context, it is conceivable that the machine tool 1 comprises a first control unit for the tool change and a second control unit for the production process. In the first control unit parameters for the tool change are stored and in the second control unit parameters for the production process are stored. Both control units can access a common memory in which the parameters are stored.

The tool feed 3 comprises a transport device 9 for transporting the tools 5. This transport device is designed in the present case as a conveyor belt, wherein the tools 5 are transported in a circulating manner on the transport device 9. The tool feed 3 is also equipped with a reading device 10 for reading the machine-readable codes 7 attached to the tools 5.

For the exchange of the tool 5, the tools 5 are transported in circulation over the transport device 9 until the reading device 10 has detected the tool 5 belonging to the article to be produced of the current production order. This is then selected and is fed in automated fashion to the tool receptacle 2 via a feed device belonging to the tool feed 3 and is automatically fastened to the tool receptacle 2. The fitting time can be reduced if the tools 5 are transported via the transport device 9, and, for each tool 5 that passes the reading device 10, it is checked whether there is a production order for the article assigned to the tool 5. If so, the tool 5 is selected and installed. If not, the tools 5 are transported further.

The feeding device comprises pneumatic actuating means by which the tools 5 can be moved in the direction of the tool receptacle 2. In the present embodiment, the tool receptacle 2 comprises hydraulic clamping means by which the tool 5 can be fastened to the tool receptacle 2 interlockingly or with frictional engagement. The clamping means are equipped here with sensors and can be actuated via the control unit 6.

Once a predefined number of articles has been produced, the next article is taken from the list and the associated tool 5 is attached to the tool receptacle 2 after the previous tool 5 has been removed. The change of the tool 5 as well as the setting of the production parameters are automated and no manual intervention is required.

The articles produced with the machine tool 1 are mostly fed to transport containers, for example boxes. For this purpose, the machine tool 1 is provided with an ejection device, for example in the form of a blow-out unit. The control unit 6 can be set up here to initiate an exchange of the transport container when a tool change is carried out. In this way, it can be ensured that the produced articles are stored and transported according to type. The transport containers can be moved here in a device comparable to the transport device 9. The holding capacity of the transport container is dependent on the size of the article. Information on the size of the article is stored in the control unit 6 so that the transport container can be automatically replaced when the capacity has been exhausted.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A machine tool for the shaping production of an article, comprising:
a tool receptacle;
a tool feed,
a stock of tools; and
a controller,
wherein the machine tool is configured to select one of the tools from the stock in dependence on the article to be produced and to fasten the article to the tool receptacle.

2. The machine tool as claimed in claim 1, wherein the tools are equipped with a machine-readable code.

3. The machine tool as claimed in claim 2, wherein the code is configured to be read remotely.

4. The machine tool as claimed in claim 1, wherein the controller comprises a memory,
wherein a list of articles to be produced is stored in the memory, and
wherein a tool of the tools and a machine-readable code belonging to the tool are assigned to the articles to be produced.

5. The machine tool as claimed in claim 1, wherein the controller comprises an input device for selecting the article to be produced.

6. The machine tool as claimed in claim 4, wherein the controller uses the list to determine the tool required for producing the article.

7. The machine tool as claimed in claim 1, wherein the tool feed comprises a transport device for transporting the tools.

8. The machine tool as claimed in claim 1, wherein a reading device for reading the code is assigned to the tool feed.

9. The machine tool as claimed in claim 7, wherein the tools pass the reading device during transport by the transport device, and
wherein the reading device detects the code.

10. The machine tool as claimed in claim 1, wherein the machine tool is an automatic stamping machine.

11. A method for producing an article using the machine tool as claimed in claim 1, the method comprising:
in a first step, determining an article to be produced and the tool required for production of the article,
in a second step, selecting a tool from the stock of tools,
in a third step, fastening the tool to the tool receptacle, and
in a fourth step, providing article-specific production parameters by the control device.
